(19) United States
(12) Patent Application Publication
(10) Pub. No.: US 2007/0244822 A1
(43) Pub. Date: Oct. 18, 2007

(54) Portable link drive

(76) Inventor: Josh N. Hogan, Los Altos, CA (US)

Correspondence Address: Josh Hogan, 620 Kingswood Way, Los Altos, CA, 94022, US

(21) Appl. No.: 11/786,483

(22) Filed: Apr. 11, 2007

Related U.S. Application Data
(60) Provisional application No. 60/792,185, filed on Apr. 14, 2006.

(51) Int. Cl. H04L 9/00

(52) U.S. Cl. 705/57

(57) ABSTRACT

A method, apparatus and system for distributing movies, video, images, audio or music and games or software in general in an electronic digital format which is convenient for users and securely protects the rights of content owners is described. The invention includes a portable secure memory device, referred to as a Portable Link Drive, that facilitates convenient use of digital data distributed over the Internet and displayed, played or used on consumer electronic devices, such as a TVs and speakers.

### FIELD OF THE INVENTION

The invention, application docket number JH070411US, claims priority from U.S. provisional application Ser. No. 60/792,185 filed on Apr. 14, 2006, titled “Portable Link Drive”. The invention relates to secure distribution and use of proprietary digital information and in particular to the secure distribution and playing of video, movies, images, audio or music and games with appropriate management of rights associated with the digital information. The invention includes a portable secure memory device, referred to as a Portable Link Drive, that facilitates convenient use of digital data distributed over the Internet and displayed, played or used on consumer electronic devices, such as a TVs and speakers. This invention also relates to digital rights management of software in general.

### BACKGROUND OF THE INVENTION

Music, movies and games are routinely distributed as digital information by distributing physical storage media such as CDs and DVDs. More recently such information is being distributed electronically over digital communications networks such as the Internet or broadband cable. Music, in particular, is now frequently downloaded over the internet to portable consumer digital storage devices such as the iPOD.

There are considerable cost and convenience advantages in distributing movies, and software in general, as electronic digital data without the burden of distributing a physical medium that also may need to be returned in the case of rental arrangements. Costs associated with a physical medium include the medium cost plus shipping and handling costs. Convenience aspects include having to obtain and return the physical media and/or shipping delays.

The data rates available on typical consumer networks, such as the Internet are sufficient for downloading music and the storage capacity of portable consumer digital storage devices is sufficient to store significantly large music libraries, typically in a compressed format, using a standard digital compression scheme such as MP3. Movies, however, require a higher data rate and larger storage capacity.

Movies stored on DVDs in a compressed format such as MPEG 2 typically have an average data rate of 3 to 5 Mega-bits per second and require 4 to 9 Gigabytes of storage capacity. While compression technology is improving, for example MPEG 4 improves compression by a factor of about 1.5 over MPEG 2 with similar quality. The requirement for higher resolution is increasing with the deployment of higher definition TV displays. This increasing data rate requirement will limit the suitability of the Internet for real-time distribution of movies.

Internet data rates, as well as being limited in speed are also typically intermittent, in that a sustained connection for period of several hours is likely to fail periodically and require multiple restarts. This makes direct use of the Internet unsuitable for widespread use for real-time viewing. Furthermore internet connection is typically to a computer such as a PC (personal computer) and there is considerable consumer preference for viewing movies on a TV, especially in family or communal viewing situations.

In most situations there is qualitative difference in the use models of the PC and TV. A PC is more suitable for browsing the various Internet web-sites to select and download movies, or software in general, while the TV is in general the preferred movie viewing environment. A bridging mechanism is therefore required between the PC and TV. Recordable DVDs with standardized formats could currently perform this bridging mechanism.

TVs now have typically associated DVD players and PCs typically have DVD record capability. As conventional resolution DVD recordable formats finally become standardized, recordable DVDs could be the bridging mechanism between the PC and the TV, however, there are still record time and organization issues that make this unattractive. Also multiple evolving formats for high definition recordable discs and incompatibilities reduce the attractiveness of this approach. Furthermore, the owners of the movie rights, the content owners, try to discourage the ability to record movies on DVDs by various copy protection mechanisms.

Digital rights refers to the rights that content owners, such as movie owners sell to consumers. Such digital rights typically involve rights to view a movie, sometimes for a limited time period. Such rights typically require inhibiting unauthorized copying of unprotected versions of the movie. Appropriate dealing with these rights is typically referred to as digital rights management.

Video consumer electronic devices, such as TVs, Set Top Boxes and DVD players are now routinely being shipped with digital electronic ports, such as USB or various variations of IEEE 1394. These ports facilitate playing movies, movie clips, games and images from digital camcorders, digital cameras and other consumer electronic devices through these digital ports. Increasingly these ports also have encryption processing and key exchange capabilities for receiving digital movies with appropriate copy protection and digital rights management.

The availability of digital ports on TVs and other consumer entertainment devices provides an opportunity to introduce new movie or video delivery mechanisms, however the combination of lack of compatibility with installed infrastructure and the copy protection mechanisms limit convenient interaction between movies, games, etc. downloaded to a PC being viewed on a TV. Furthermore it is inconvenient for users do have to control the play, stop, reverse, etc. aspects of the movie from a PC.

Alternative movie distribution mechanisms have been proposed. One example is to have kiosks ubiquitously located that digitally store a large number of movies. A consumer could then go to one of these kiosks and download a movie to a portable storage device. Suitable portable storage devices based on flash memory (non-volatile semiconductor memory) or hard disc. Such devices include “jump drives” which contain flash memory and a USB digital interface and also include the “iPOD” which contains either hard disc or flash memory and an “iLINK” or Firewire based interface.

This approach to movie distribution provides an opportunity to distribute movies in a secure manner that protects content owner's rights. This can be done by only downloading movies to portable storage devices that include copy protection protocols that will only transmit the proprietary data (the movie as digital data) to an authorized display device that in turn will only re-transmit the proprietary data to authorized storage or display devices.

However, this distribution approach requires relatively expensive high capacity portable storage devices and allocating significant multiple Giga-bytes of storage in the portable device to the specific task of movie storage. It requires development and deployment of multiple robust high speed digital interfaces, to minimize download times. It also requires the deployment of multiple movie kiosks. These must all have significant terra-bytes of storage capacity for a large movie library with multiple high speed digital interfaces for rapid downloading to ensure acceptable download times to user devices. This involves developing and deploying novel infra-structures.

These aspects of disconnect between Internet attached PCs, incompatibilities between consumer electronic devices and protocols, and infra-structure issues associated with solutions such as movie kiosks limit the suitability of current techniques for distributing movies as digital data.

There is therefore an unmet need for a convenient system for digitally distributing movies and other digital information in a secure manner that appropriately manages and protects the rights of the content owners and is compatible with existing infra-structures.

### SUMMARY OF THE INVENTION

The invention provides a method, apparatus and system for distributing movies, video, images, audio or music and games or software in general in an electronic digital format which is convenient for users and securely protects the rights of content owners. The invention includes a portable secure memory device, referred to as a Portable Link Drive, that facilitates convenient use of digital data distributed over the Internet and displayed, played or used on consumer electronic devices, such as a TVs and speakers. The invention includes a wireless link to the cryptographically secure Portable Link Drive that contains non-volatile memory, buffer memory and a high speed digital interface. The device can store cryptographic related data and digital rights related data in a secure manner. The device can receive and decrypt data that is specific to the device and can re-encrypt and transmit the encrypted data to authorized storage and display devices. This invention also relates to digital rights management of software in general.

### BRIEF DESCRIPTION OF THE DRAWINGS

FIG. 1 is an illustration of the portable link drive according to the invention.

FIG. 2 is an illustration of a secure distribution system according to the invention.

FIG. 3 illustrates an arrangement for playing downloaded protected digital content.

### DETAILED DESCRIPTION OF THE INVENTION

The present invention provides a method, apparatus and system for electronic distribution of digital content with secure digital rights management. It is suitable for distributing movies and other digital content in an electronic digital format which is convenient for users, is compatible with existing infra-structures and securely protects the rights of content owners. This electronic distribution and secure rights management system is described in the context of distributing movies electronically, however, it is suitable for distributing software in general.

The secure and convenient distribution system uses the data distribution capabilities of conventional networks, such as the Internet, to distribute encrypted or appropriately secure data to consumer computers, herein referred to as PCs. The encrypted data is protected against inappropriate use by the fact that it is encrypted and therefore may be stored on hard disc or removable storage medium, such as DVD+RW, without jeopardizing the integrity of its protection. The encrypted data may also be re-transmitted over physical or wireless communication channels without jeopardizing the integrity of its protection.

The secure distribution system also includes a low cost compact portable secure memory or storage device, referred to as a Portable Link Drive, that is cryptographically secure, to store and use decryption keys and digital rights data. The Portable Link Drive constitutes a bridge or link between the PC based Internet environment and the consumer electronics based entertainment world of the TV that can be as cryptographically secure as appropriate for the data.

The Portable Link Drive uses low cost buffer memory and multiple data exchange and control interfaces to enable the Portable Link Drive to perform in a manner similar to existing movie players (such as DVD players) and be controlled similarly by a remote IR controller and thereby enable a convenient and secure method of playing on a TV movies that are stored on a PC. This enables a convenient evolution path to distributing high definition movies without the requirement or cost of deploying high definition DVD players.

The Portable Link Drive also enables more extensive use of the combination of digital content distribution over the internet and viewing or playing on TV. For example, downloading and viewing sports events, news coverage from distant regions, educational programs, technical or professional training programs. For purposes of this application, playing includes, but is not limited to, viewing on TV or other visual display devices, or listening to with speakers or earphones. Also, for purposes of this application digital content includes, but is not limited to, all forms of multimedia such as movies, video, images, audio or music, games, training and educational programs and also includes software in general. The Portable Link Drive also facilitates home movies edited or composed on a PC being viewed on a TV. Distribution includes transferring movies resident on a PC to the display device without the use of the Internet.

The secure distribution and playing system may be used to distribute and play encrypted or partially encrypted multimedia but may also be used to distribute and play freely available multimedia including public domain movies and home movies. For purposes of this invention “securely encoding” includes encoding appropriate for the content, which can include encryption, partial encryption, scrambling, partial scrambling, watermarking, and other forms of copy protection or, for example, in the case of public domain movies encoding with no copy protection measures (since the content is freely available and therefore the digital rights are secure with no protection). Digital content encoded with appropriate regard to its digital rights is herein referred to as secure digital content. Similarly, distributing, playing, downloading and transferring digital content with appropriate regard to its digital rights is herein referred to as securely distributing, playing, downloading and securely transferring.

In the preferred embodiment of the secure distribution system the Portable Link Drive is connected to the Internet, for example, by way of a standard computer. The Portable Link Drive is cryptographically authenticated by the content owner or an agent acting for the content owner. Once authenticated, the user (or owner of the Portable Link Drive) can purchase digital rights, for example, to view a movie. The user can be billed for payment by any of the existing standard Internet payment methods.

The purchased digital rights and decryption keys (referred to as security data) are downloaded to and stored in the Portable Link Drive and the movie is downloaded in the form of an encrypted digital file or files (or secure digital content) over a standard network, such as the Internet, to a PC specified by the user. Encryption can be accomplished using a standard cryptographic module. Downloading the movie may take minutes to many hours depending on the internet connection data rate, the movie length and the display resolution. Downloading may be optimized by fragmenting the movie data into many small segments with verification, and if necessary re-transmission, of each segment until the complete movie is downloaded.

Multiple movies can be downloaded and stored on the PC hard disc or external hard disc or removable recordable medium such as DVD+RW. There is no requirement to further protect this encrypted data as it cannot be decrypted without the involvement of the Portable Link Drive containing the decryption keys and the digital rights data. Therefore the encrypted data can be re-transmitted without jeopardizing the integrity of its digital rights.

In the preferred embodiment, when the user wishes to view the movie the Portable Link Drive is connected to an authorized display device or TV by means of an electronic interface such as IEEE 1394, Firewire, iLINK or USB (universal serial bus). The encrypted data (or secure digital content) is wirelessly transmitted by the PC to the Portable Link Drive. The device stores the encrypted data in buffer memory. As a result of the transaction to acquire the digital rights to view the movie, the Portable Link Drive also has the decryption key or keys (or security data) required to decrypt the movie. For purposes of this invention security data includes such digital rights and decryption keys as well as other data related to the proprietary nature of the content, which in the case of freely available or home movies could be null data.

The Portable Link Drive establishes and authenticates that the display device to which it is connected is an authorized device that will appropriately protect the digital rights of the content owner, by conventional cryptographic authentication techniques. Once authenticated, the Portable Link Drive securely transmits the decryption key and makes the encrypted data available for display as a movie under appropriate digital rights management. In the case of freely available movies or home movies authentication could be a null operation (i.e. authentication is automatically available or not required). Typically authentication would not be required to display menu information, freely available movies or home movies.

An on-going data exchange protocol between the PC and the Portable Link Drive over the wireless channel replenishes the encrypted data in the buffer memory to maintain sufficient data in the buffer memory so that continuous uninterrupted playing of the movie is ensured. This data exchange can include the Portable Link Drive sending buffer fullness and address data to the PC. This allows the PC to perform most of the processing and data flow control for the movie to be played normally without interruption. Processing for the various trick play modes (slow mode, fast forward, etc.) can also be substantially performed by a combination by the PC and the display device with minimal processing burden on the Portable Link Drive.

In the preferred embodiment the Portable Link Drive also has an IR (infra red) interface similar to those used to control TVs, or DVD or VCR players. The control data from the IR interface is routed to and incorporated into the wireless data exchange protocol with the PC. This allows the user to control the operation of the Portable Link Drive and hence the movie in a similar manner to a DVD or VCR player.

In this manner the Portable Link Drive enables a secure movie distribution system that exploits the existing data distribution capabilities of conventional networks such as the Internet. It also exploits the substantial storage capacity, processing power and wireless communication capability of conventional PCs. The system thus enabled allows users to download movies to their PCs in a standard manner but to view them in a conventional TV environment and with appropriate protection of the digital rights of the content owner.

The Portable Link Drive can be controlled by a conventional IR remote control device and there is no requirement to develop novel infra-structure. The enabling Portable Link Drive can be implemented with a combination of conventional technologies including flash memory. Because the flash memory is used as a buffer memory a relatively small amount is required allowing the Portable Link Drive to be a compact and low cost device. The Portable Link Drive may also fulfill the data storage role already played by existing jump drives.

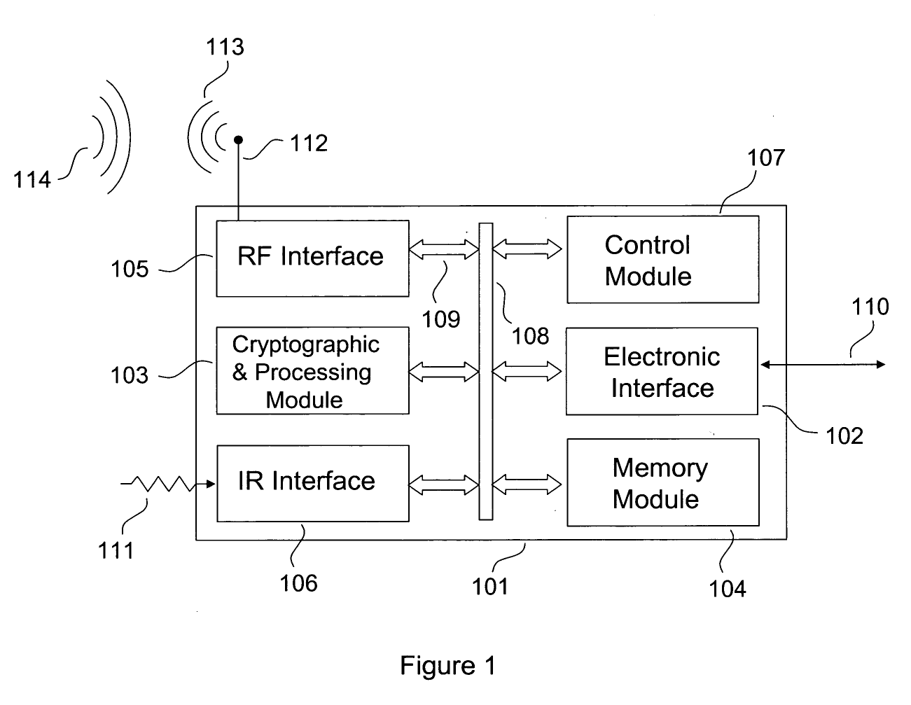

A preferred embodiment of the Portable Link Drive that enables the secure distribution system is illustrated in and described with respect to FIG. 1 where the Portable Link Drive 101 is shown in block diagram form. It includes a high speed electronic interface 102, a cryptographic module 103, a memory module 104, an RF interface 105, an IR interface 106 and a control module 107 all of which are connected by a conventional bus 108 and bi-directional I/Os one of which is indicated by 109.

The high speed electronic interface 102 allows connection to other electronic devices by means of an electronic port 110. Suitable electronic ports include, but are not limited to, the Universal Serial Bus (USB) and various variations of the IEEE 1394 port such as Firewire and iLink. When acquiring digital rights to view a movie, the Portable Link Drive 102 is connected by way of the electronic port 110 to a device that provides access to the Internet. Such devices that provide access to the Internet include, but are not limited to, computers, work-stations, PDAs, cell phones, and computer peripherals and are herein referred to as Internet access devices.

The Portable Link Drive 101 contains unique cryptographically secure identification such as a conventional public/private key combination or equivalent cryptographic protocol. For purposes of this application, the public private key protocol will be used in the preferred embodiment description, however other cryptographic protocols and copy protection protocols could be used and are therefore included.

In the preferred embodiment the content owner uses the Portable Link Drive's public key to authenticate the Portable Link Drive. Authentication includes verifying that the portable storage device is the owner of the public key and that appropriate payment (if required) for the digital rights being acquired has been or will be made. For example, rights could be to view the movie for a three day period and payment could be a pre-paid monthly subscription or a one time credit card payment.

Once authentication has been successfully accomplished, an encrypted version of the movie, referred to as secure digital content, that is selected by the user is downloaded or scheduled for downloading over the Internet by the content owner or an agent of the content owner to the PC nominated (or identified by IP address) by the user and referred to as a selected computer system. The decryption data (or security data), which can include key (or keys), required to decrypt the encrypted movie (or portions of the movie), is securely downloaded or cryptographically transferred to the Portable Link Drive and stored in a cryptographically secure manner by the cryptographic module 103 of the Portable Link Drive 101.

The cryptographic module 103 includes the secure tamper resistant non-volatile memory and circuitry. The cryptographic module 103 enables the Portable Link Drive to perform cryptographic functions that include authentication, key exchange or transfer, and securely storing in non-volatile memory, security data or encryption related data, such as keys, and digital rights and these functions may also may include decryption and re-encryption of the encrypted movie data. For purposes of this invention security data includes any encryption related data, such as, decryption or encryption keys and authentication data. The tamper resistant non-volatile memory may be a portion of the memory module 104 that is only accessible in a cryptographically secure manner or may be securely stored in accessible memory by virtue of being encrypted.

Downloading the selected movie (or movies) can be done by conventional file transfer over the Internet. Since movies are typically large amounts of data, downloading may be optimized by fragmenting the movie data into smaller segments, downloading and verifying (or resending if necessary) the segments and re-assembling the segments after they have been successfully received. Alternatively final re-assembly may be done in the Portable Link Drive.

Downloading times depend on available data rates which typically increase over time. Available download data rates are competitive with mail order delivery times and often with pick-up times from rental stores. Furthermore, the distribution system described in this invention separates the distribution of the encrypted movie data and the exercise of the acquired digital rights, which facilitates digital rights that allow downloading multiple movies ahead of time and later, at a time of the user's choosing, viewing one or more of the movies.

This separation between the digital rights management and decryption keys necessary to view a movie on the one hand and the encrypted data that represents the movie on the other hand coupled with the fact that the Portable Link Drive is integral in playing the movie provides very flexible ordering, viewing and billing capabilities.

Flexible ordering capabilities include ordering a movie from one of many internet access devices and having the encrypted movie downloaded to one or more different PCs. It includes the opportunity to abort viewing an unsatisfactory movie. Flexible viewing capabilities include having a significant number of un-viewed movies stored on one or more PCs or stored on removable storage media. Flexible billing capabilities include a flat monthly fee that allows a fixed number of movies to be viewed each month, or a specific fee per specific movie for a fixed number of viewings or viewing over a fixed period of time, or providing a rebate or credit for partially viewed unsatisfactory movies.

In order for a downloaded movie to be viewed the Portable Link Drive 101 is connected to an authorized display device such as a TV (either directly or through an intermediate consumer electronic device such as a Set Top Box or a DVD player) by the electronic port 110 which also may supply power to the Portable Link Drive. The Portable Link Drive includes an IR interface 106 which receives an IR (infra-red) signal 111 from a conventional remote controller such as is used to control a TV, VCR or DVD player.

The IR control information is processed by a control module 107 which communicates with the PC on which the encrypted movie data is stored by means of an RF interface 105 through an aerial 112 (which may be internal to the Portable Link Drive). A bi-directional RF or wireless connection, indicated by 113 and 114 is established between the Portable Link Drive 101 and the PC on which the encrypted movie (or movies) is stored using a conventional RF or wireless communication protocol such as the 803.11 standard.

The combination of the control module 107, the remote control IR information and the bi-directional wireless enables outputting an un-encrypted MPEG signal to the display device to visually display movie titles and allow selection and control similar to control displays initiating operation conventional VCR or DVD players. In this way an encrypted movie on the PC can be selected for viewing or playing.

When a movie is selected the control module 107 causes the cryptographic module 103 to verify that the viewing the movie is compatible with the acquired digital rights. If appropriate digital rights are confirmed the control module 107 causes the cryptographic (and processing) module 103 to authenticate that the display device is compliant and therefore will comply with the acquired digital rights and securely process data (including security data) if required.

After successful authentication the control module 107 causes the cryptographic module 103 to securely transfer the decryption key (or security data) related to the selected encrypted movie to the display device (the TV). The control module 107 then initiates transfer of the encrypted movie data or secure digital content from the PC to the memory module 104 of the secure Portable Link Drive 101 by means of the wireless connection to the RF interface 105. The Portable Link Drive 101 then makes the encrypted movie data or secure digital content available to the display device.

In an alternative embodiment the Portable Link Drive 101 decrypts the encrypted movie and re-encrypts it with a different key which it securely transfers to the display device or transfers the unencrypted movie to the display device using other copy protection mechanisms. In yet another alternative embodiment the encrypted movie or secure digital content is transferred directly from the PC to the display device, with the portable link drive providing the security related data. For purposes of this invention, all of the above transfer mechanisms are referred to as securely transferring the secure digital content from the selected computer system to the authorized display system;

In the preferred embodiment, when a predetermined amount of the memory module 104 is substantially full of encrypted movie data the control module 107 initiates transfer of the encrypted movie data from the memory module 104 through the electronic interface 102 and the electronic port 110 to the authenticated display device (the TV) which decrypts the data, decodes the resulting compressed MPEG bit stream and displays (or plays) the movie.

The predetermined amount of the memory module 104 acts as a buffer memory. The control module 107 monitors the status (or buffer fullness) of the predetermined amount of the memory module 104 and replenishes the buffer memory through the wireless connection as it is depleted by transfer of the encrypted movie data to the display device. The buffer memory is thus maintained at least partially full which ensures there is always sufficient encrypted data available to support continuous uninterrupted playing or viewing of the movie.

The operation of the secure Portable Link Drive can be controlled in a manner similar to a VCR or DVD player by means of an IR remote control through the IR interface 106. The IR control data is sent to the control module 107 which controls the flow of encrypted data from the PC over the wireless connection 114 and 113 and to the display device through the electronic port 110. The set of remote control functions thus enabled includes, but is not limited to, play, stop, various fast forward modes, slow mode, reverse play as well as standard menu functions and for purposes on this invention are referred to as play operation.

In this manner the Portable Link Drive acts as a virtual player that seamlessly links the vast information access capabilities of networks, and in particular the Internet, with the convenient and consumer accepted viewing environment of the TV. It contains cryptographic security capabilities that enable appropriate digital rights management and facilitates the distribution of both regular and high definition movies, home movies and other digital content.

For purposes of this invention, controlling the play operation of the Portable Link Drive includes: using the remote control IR data to initiate the communication between the Computer System C and the Portable Link Drive; transferring un-encrypted data, such as a visual menu for movie selection, and playing it on the display device; executing or causing the PC to execute selected menu operations; securely transferring the secure digital content; and executing standard control functions of VCR or DVD players, such as, play, stop, various fast forward modes, slow mode, reverse play.

In addition to movies, other digital content includes, but is not limited to, sports events video, news coverage from distant regions, educational programs, technical or professional training programs, images, audio or music and games or software in general. It also includes free digital content, such as home movies or content that is freely available on the Internet.

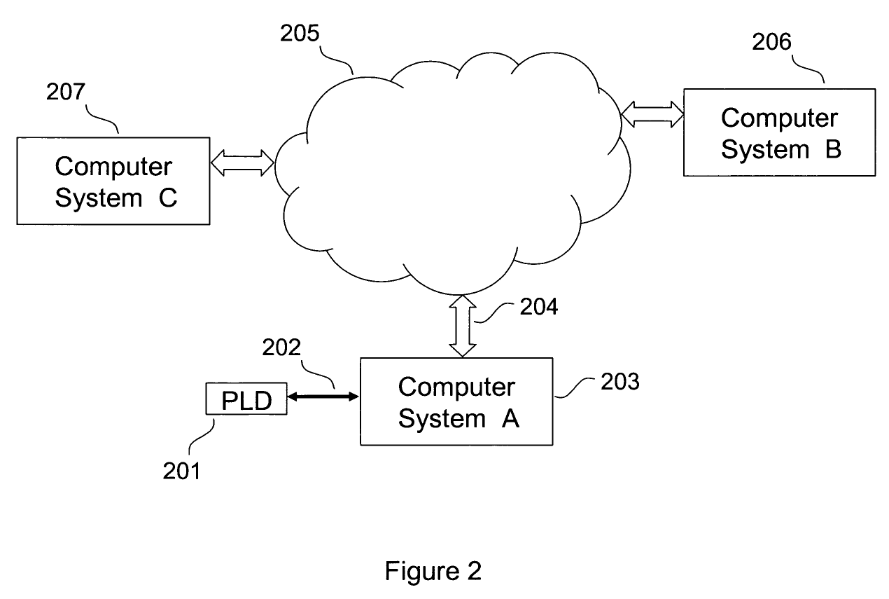

Digital content of various types can be acquired over the Internet in the same manner as movies can be acquired. This is illustrated in and described with respect to FIG. 2 where the Portable Link Drive 201 is connected by an electronic port 202 such as USB to a computer 203 such as a PC, labeled Computer System A, with a connection 204 to a network such as the Internet indicated by the cloud 205. Computer System A may be the user's home computer, work computer, computer in a store, or any computer that is software enabled to authenticate a Portable Link Drive. Using Computer System A the user browses the Internet and selects particular digital content on a particular web-site labeled Computer System B 206.

Authentication, if required, is accomplished using conventional techniques, such as those using public and private keys. Authentication may require enabling a software module, which can be from the Portable Link Drive or over the Internet triggered by the Portable Link Drive. Authentication may also all authorized Portable Link Drives being registered and a list of compliant authorized Portable Link Drives being available in a cryptographic secure manner.

After successful authentication and agreement to the terms of the digital rights transaction, payment (if required) is authorized by the user (owner of the Portable Link Drive) and a decryption key or keys and the digital rights are transferred to the Portable Link Drive in a cryptographically secure manner. The content owner or content owner's agent encrypts or partially encrypts (or securely encodes) the selected digital content using the decryption key or keys that were transferred to the Portable Link Drive.

The encrypted or secure digital content is then downloaded over a network, such as the Internet, to a Computer System C, which is designated or selected by the user and to which the user typically has access. Computer System C may be the same system as Computer System A or a different computer system. Downloading the digital content may involve fragmenting the digital content into multiple segments, sending and verifying that each segment has been successfully been received, re-sending if necessary and a software module that orchestrates this and re-assembles the complete set downloaded fragments.

Typically the digital content that is downloaded will contain un-encrypted data as well as encrypted data. The un-encrypted data may be data describing the content, such as the title of a movie. It may also include un-encrypted portions of the movie, such as Group of Picture (GOP) header information, that is useful in controlling display of the movie. For purposes of this invention secure digital content includes the complete digital content comprised of un-encrypted and encrypted portions.

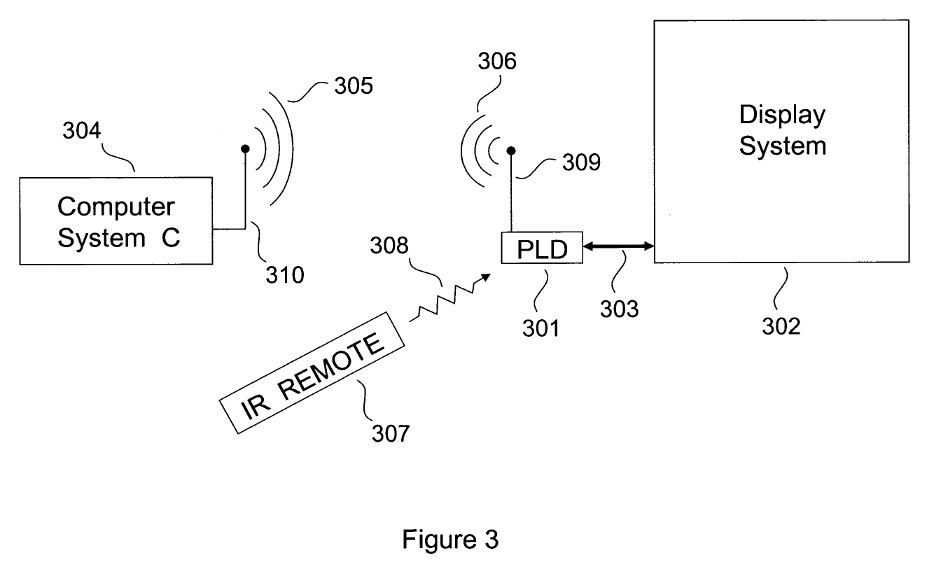

When the complete digital content is successfully downloaded and re-assembled, or a large enough portion thereof to ensure that, for the download data rate available, the content will be downloaded and re-assembled when required, the content may be accessed by the authorized user. In the preferred embodiment playing the digital content is illustrated in and described with respect to FIG. 3, where the example of viewing a movie is further described.

The Portable Link Drive 301 is connected to an authorized TV or authorized display device 302 by means of an electronic interface 303 such as IEEE 1394, Firewire, iLINK or USB (universal serial bus). The encrypted data is wirelessly transmitted by the Computer System C 304 to the Portable Link Drive 301. The device stores the encrypted data (or secure digital content) in buffer memory. As a result of the transaction to acquire the digital rights to view the movie, the Portable Link Drive 301 also has the decryption key or keys (or security data) required to decrypt the movie.

The Portable Link Drive 301 establishes and authenticates that the display device 302 to which it is connected is an authorized device that will appropriately protect the digital rights of the content owner, by conventional cryptographic authentication techniques. Once authenticated, the Portable Link Drive 301 securely transmits the decryption key and makes the encrypted data available for display as a movie under appropriate digital rights management. In an alternative embodiment, the Portable Link Drive 301 decrypts and re-encrypts the digital content or employs other copy protection mechanisms compatible with the authorized display device. For purposes of this invention securely transferring the securely encoded digital content includes any cryptographic processing or analysis operation necessary to securely transfer the digital content in an appropriate manner to the authorized display device.

If required (due to limited memory) an on-going data exchange protocol between the Computer System C 304 and the Portable Link Drive 301 over the wireless channel 305 and 306 replenishes the encrypted data in the buffer memory to maintain sufficient data in the buffer memory so that continuous uninterrupted playing of the movie is ensured. The wireless channel 305 and 306 may employ aerials 309 and 310 which may also be incorporated within the PLD 301 and Computer System C 304 respectively.

In the preferred embodiment the Portable Link Drive 301 also has an IR (infra red) interface 307 similar to those used to control TVs, or DVD or VCR players. The control data from the IR interface is routed to the PLD 301 by means of the infra-red signal 308 and incorporated into the wireless data exchange protocol with the Computer System C 304. This control data is used to control the flow of un-encrypted and encrypted data from Computer System C 304 to the PLD 301 and then to the Display System 302.

Thus the preferred embodiment allows the user to control the operation of the Portable Link Drive 301 and hence play the movie in a similar manner to that of controlling and playing a conventional DVD or VCR player. Furthermore this is accomplished in a convenient manner that is compatible with existing infra-structures and that appropriately manages and protects the rights of the digital content owner.

In general the invention enables a very flexible and convenient link between the extensive access to content of the Internet and convenient playing (or viewing) of content on consumer devices such as the TV. It is suitable for viewing movies, sports events, news events, games, etc either previously downloaded or streaming over the Internet. The invention also provides a flexible mechanism for appropriately protecting digital rights of content, including, but not limited to: pay per view movies or sports events; monthly or periodic subscriptions for access to movies, sports events, etc.; home movies, public domain or payment free content; interactive game playing.

It is understood that the above description is intended to be illustrative and not restrictive. Many of the features have functional equivalents that are intended to be included in the invention as being taught. For example, a Display System includes a Set Top Box (STB) or DVD connected to a TV. A computer system includes a memory device with an IP address which may be accessed by means of a web address or URL. Network connections may be by means of routers, network switches, etc whose order can be varied.

An authenticated display device may be a TV or an STB or DVD connected to a TV using standardized secure digital transmissions schemes such as, DVI/HDMI High-bandwidth Digital Content Protection (HDCP) or IEEE 1394 Digital Transmission Content Protection (DTCP). Encryption schemes other than the public/private key scheme may be used. Digital interfaces other than USB and IEEE 1394 could be used. Video encoding schemes other than MPEG could be used.

This system may be used for distributing and displaying digital content other than movies, such as video, images, audio, music, games and software. Software can include software design tools. The system may be used to play home movies where no internet downloading is required and no encryption or authentication is required.

The wireless connection between the computer System and the PLD could be replaced by a conventional wired connection (in which case the PLD would not require a wireless or RF interface). Transferring includes both wireless and wired transmission. The PLD could avail of an existing wireless connection within a display device, TV, STB or DVD into which the PLD plugged. A wireless port could also used to transfer the security data to the PLD. The computer system could be contained within the display device, TV, STB or DVD and could be a memory device with an IP address which may be accessed by a web address or URL. The PLD could be incorporated in other portable devices, such as, an iPOD.

The securely encoded digital content could be transferred directly from the computer system to the display device and the PLD used to supply the security data and control the play operation. The infra red remote control system could be replaced by a wireless RF remote control system which could communicate with the PLD or with both the PLD and the computer system.

All of the embodiments are amenable to any computer readable mediums, in the form of an executable program that performs the steps as outlined in the figures.

Other examples will be apparent to persons skilled in the art. The scope of this invention should be determined with reference to the specification, the drawings, the appended claims, along with the full scope of equivalents as applied thereto.

What is claimed is:

1. A method for securely distributing and playing digital content comprising:
securely encoding said digital content to form secure digital content;
securely downloading security data related to said secure digital content to a portable link drive;
downloading said secure digital content to a selected computer system;
connecting said portable link drive to an authorized display system;
remotely controlling the play operation of said portable link drive;
processing said security data in said portable link drive;
securely transferring said secure digital content from said selected computer system to said authorized display system; and
securely playing the digital content.

2. The method of claim 1, wherein the secure digital content is transferred from the selected computer system to the authorized display system by first transferring the secure digital content to the portable link drive and then from the portable link drive to the authorized display system;

3. The method of claim 2, wherein the securely encoded digital content is transferred from the selected computer system to the portable link drive by means of a wireless connection;

4. The method of claim 1, wherein the portable link drive is connected to the authorized display system by a Universal Serial Bus electronic interface.

5. The method of claim 1, wherein the portable link drive is connected to the authorized display system by a IEEE 1394 electronic interface.

6. The method of claim 1, wherein remotely controlling the play operation of the portable link drive is by means of an infra red remote control device.

7. The method of claim 1, wherein the digital content is multimedia content.

8. The method of claim 7, wherein the multimedia content is a movie.

9. The method of claim 7, wherein the multimedia content is a game.

10. A system for securely distributing and playing digital content comprising:
a cryptographic module operable to encode said digital content to form secure digital content;
an interface operable to securely download security data related to said secure digital content to a portable link drive;
a system operable to download said secure digital content to a selected computer system;
an interface operable to connect said portable link drive to an authorized display system;
a module operable to remotely control the play operation of said portable link drive;
a module operable to process said security data in said portable link drive;
an interface operable to securely transfer said secure digital content from said selected computer system to said authorized display system, wherein said digital content is securely played on said authorized display system.

11. An apparatus for securely distributing and playing digital content, said apparatus comprising:
means for securely encoding said digital content to form secure digital content;
means for securely downloading security data related to said secure digital content to a portable link drive;
means for downloading said secure digital content to a selected computer system;
means for connecting said portable link drive to an authorized display system;
means for remotely controlling the play operation of said portable link drive;
means for processing said security data in said portable link drive;
means for securely transferring said secure digital content from said selected computer system to said authorized display system; and
means for securely playing the digital content.

12. The apparatus of claim 11, wherein the secure digital content is transferred from the selected computer system to the authorized display system by first transferring the secure digital content to the portable link drive and then from the portable link drive to the authorized display system;

13. The apparatus of claim 12, wherein the securely encoded digital content is transferred from the selected computer system to the portable link drive by means of a wireless connection;

14. The apparatus of claim 11, wherein the portable link drive is connected to the authorized display system by a Universal Serial Bus electronic interface.

15. The apparatus of claim 11, wherein the portable link drive is connected to the authorized display system by a IEEE 1394 electronic interface.

16. The apparatus of claim 1 1, wherein remotely controlling the play operation of the portable link drive is by means of an infra red remote control device.

17. The apparatus of claim 11, wherein the digital content is multimedia content.

18. The apparatus of claim 17, wherein the multimedia content is a movie.

19. The apparatus of claim 17, wherein the multimedia content is a game.

20. A computer readable medium containing an executable program for securely distributing and playing digital content, where the program performs the steps of:
securely encoding said digital content to form secure digital content;
securely downloading security data related to said secure digital content to a portable link drive;
downloading said secure digital content to a selected computer system;
connecting said portable link drive to an authorized display system;
remotely controlling the play operation of said portable link drive;
processing said security data in said portable link drive;
securely transferring said secure digital content from said selected computer system to said authorized display system; and
securely playing the digital content.

21. The computer readable medium as in claim 20, wherein the secure digital content is transferred from the selected computer system to the authorized display system by first transferring the secure digital content to the portable link drive and then from the portable link drive to the authorized display system;

22. The computer readable medium as in claim 21, wherein the securely encoded digital content is transferred from the selected computer system to the portable link drive by means of a wireless connection;

23. The computer readable medium as in claim 20, wherein the portable link drive is connected to the authorized display system by a Universal Serial Bus electronic interface.

24. The computer readable medium as in claim 20, wherein the portable link drive is connected to the authorized display system by a IEEE 1394 electronic interface.

25. computer readable medium as in claim 20, wherein remotely controlling the play operation of the portable link drive is by means of an infra red remote control device.

26. The computer readable medium as in claim 20, wherein the digital content is multimedia content.

27. The computer readable medium as in claim 26, wherein the multimedia content is a movie.

28. The computer readable medium as in claim 26, wherein the multimedia content is a game.
